(19) United States
(12) Patent Application Publication
(10) Pub. No.: US 2025/0207766 A1
(43) Pub. Date: Jun. 26, 2025

(54) MULTI-ORIENTATION LIGHT CLIP

(71) Applicant: Shining Sea Trading Company, West Valley City, UT (US)

(72) Inventor: Jared Hendricks, Draper, UT (US)

(21) Appl. No.: 19/000,356

(22) Filed: Dec. 23, 2024

Related U.S. Application Data
(63) Continuation of application No. 18/536,077, filed on Dec. 11, 2023, now abandoned.
(60) Provisional application No. 63/386,845, filed on Dec. 9, 2022.

(51) Int. Cl. F21V 21/088; F21S 4/10

(52) U.S. Cl. CPC F21V 21/088; F21S 4/10

(57) ABSTRACT

A light clip is provided having a roof covering socket mount including an inline collar to at least partially encircle a light in a socket, opposing side supports coupled to and extending from the inline collar and spaced apart sufficiently to contain a light socket, opposing bottom side supports coupled to the opposing side supports extending from the inline collar substantially parallel to the opposing side supports to form a channel to receive a roof covering, and a securing clip coupled to the opposing bottom side supports. The light clip also includes a gutter socket mount having a gutter collar formed between the opposing bottom supports, the gutter collar configured to at least partially encircle a light in a socket and a parallel offset of the opposing side supports providing a gutter rest structurally configured to rest on a gutter top and run along an inside edge of the gutter.

### CROSS-REFERENCE TO RELATED APPLICATIONS

This application is a continuation U.S. patent application Ser. No. 18/536,077, filed Dec. 11, 2023, which claims the benefit of U.S. Provisional Patent Application No. 63/386,845, filed on Dec. 9, 2022, each of which is incorporated herein by reference in its entirety.

### BACKGROUND

Decorative lighting is often used to enhance the aesthetic feel of many indoor and outdoor locations. Such lighting can be year-round, seasonal, holiday-related, event-related, and the like. In one example, decorative lighting can be used as a holiday embellishment to decorate interiors, exteriors, trees and shrubs, landscaping structures, floats, displays, and the like. Decorative lighting is therefore a desirable addition to many residential, commercial, and government buildings. Difficulties arise during installation, however, due to the various roof line differences both between buildings and between portions of the same building. For example, in some cases it may be desirable to attach lighting to roof coverings, such as roof shingles, roof tiles, and the like. In other cases, it may be desirable to attach lighting to the edges of more vertically oriented structures, such as rain gutters, facades, or the like.

### BRIEF DESCRIPTION OF THE DRAWINGS

FIG. 1A is an illustration of a light clip device in accordance with an example embodiment;

FIG. 1B is an illustration of a light clip device in accordance with an example embodiment;

FIG. 1C is an illustration of a light clip device in accordance with an example embodiment;

FIG. 2A is an illustration of a gutter-mounted light clip device in accordance with an example embodiment;

FIG. 2B is an illustration of a gutter-mounted light clip device in accordance with an example embodiment;

FIG. 3 is an illustration of a different orientation of a light clip device in accordance with an example embodiment;

FIG. 4A is an illustration of a light clip device in accordance with an example embodiment;

FIG. 4B is an illustration of a light clip device in accordance with an example embodiment;

FIG. 4C is an illustration of a light clip device in accordance with an example embodiment;

FIG. 4D is an illustration of a light clip device in accordance with an example embodiment;

FIG. 4E is an illustration of a light clip device in accordance with an example embodiment;

FIG. 4F is an illustration of a light clip device in accordance with an example embodiment;

FIG. 4G is an illustration of a light clip device in accordance with an example embodiment;

FIG. 5 is an illustration of a light clip device in accordance with an example embodiment;

FIG. 6A is an illustration of a light clip device in accordance with an example embodiment; and

FIG. 6B is an illustration of a light clip device in accordance with an example embodiment;

### DESCRIPTION OF EMBODIMENTS

Although the following detailed description contains many specifics for the purpose of illustration, a person of ordinary skill in the art will appreciate that many variations and alterations to the following details can be made and are considered included herein. Accordingly, the following embodiments are set forth without any loss of generality to, and without imposing limitations upon, any claims set forth. It is also to be understood that the terminology used herein is for describing particular embodiments only, and is not intended to be limiting. Unless defined otherwise, all technical and scientific terms used herein have the same meaning as commonly understood by one of ordinary skill in the art to which this disclosure belongs. Also, the same reference numerals appearing in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various embodiments. One skilled in the relevant art will recognize, however, that such detailed embodiments do not limit the overall concepts articulated herein but are merely representative thereof. One skilled in the relevant art will also recognize that the technology can be practiced without one or more of the specific details, or with other methods, components, layouts, etc. In other instances, well-known structures, materials, or operations may not be shown or described in detail to avoid obscuring aspects of the disclosure.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open-ended term in this written description, like “comprising” or “including,” it is understood that direct support should be afforded also to “consisting essentially of” language as well as “consisting of” language as if stated explicitly and vice versa.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a given term, metric, value, range endpoint, or the like. The degree of flexibility for a particular variable can be readily determined by one skilled in the art. However, unless otherwise expressed, the term “about” generally provides flexibility of less than 1%, and in some cases less than 0.01%. It is to be understood that, even when the term “about” is used in the present specification in connection with a specific numerical value, support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of phrases including “an example” or “an embodiment” in various places throughout this specification are not necessarily all referring to the same example or embodiment.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device which is more likely to have write errors to it than other regions in the same memory device. A number of factors can cause such increased risk, including location, fabrication process, number of program pulses applied to the region, etc.

An initial overview of embodiments is provided below, and specific embodiments are then described in further detail. This initial summary is intended to aid readers in understanding the disclosure more quickly and is not intended to identify key or essential technological features, nor is it intended to limit the scope of the claimed subject matter.

Decorative lighting is a desirable addition to many residential, commercial, and government buildings. Difficulties arise during installation, however, due to the various roof line differences both between buildings and between portions of the same building. For example, in some cases it may be desirable to attach lighting to roof coverings, such as roof shingles, roof tiles, and the like. In other cases, it may be desirable to attach lighting to the edges of more vertically oriented structures, such as rain gutters, facades, or the like. In addition, clips intended for roof coverings have light socket mounts oriented parallel with the roof coverings. Such a light clip used on a gutter, for example, would direct the decorative light vertically, which will likely be aesthetically undesirable.

The present disclosure provides a solution for the above-mentioned issues via a light clip that can be attached to roof coverings and vertically oriented edges with the decorative light in each case being oriented properly in a separate mount in each clip depending on the attachment surface.

As one example, a light clip is provided that includes a roof covering socket mount having an inline collar structurally configured to at least partially encircle a light in a socket mounted in the roof covering socket mount, opposing side supports coupled to and extending from the inline collar and spaced apart sufficiently to contain a light socket, and opposing bottom side supports coupled to the opposing side supports at the inline collar end and extending from the inline collar substantially parallel to the opposing side supports to form a channel to receive a roof covering therebetween. A securing clip is coupled to the opposing bottom side supports and is angled upward toward the opposing side supports, such that, when a roof structure is positioned in the channel, the securing clip is elastically deformed beneath the roof structure to secure the light clip. For a substantially vertical mounting edge, such as a gutter, for example, the light clip further includes a gutter socket mount having a gutter collar formed between the opposing bottom supports and oriented such that a mounted light socket would be positioned between the opposing side supports, the gutter collar being configured to at least partially encircle a light in a socket mounted in the gutter socket mount. A parallel offset portion of the opposing side supports provides a gutter rest structurally configured to rest on a gutter top and run along an inside edge of the gutter and the securing clip is elastically deformed on an outside surface of the gutter to secure the light clip. Due to the relative locations of the socket mounts being oriented, in this example, about 90 degrees apart from one another, mounted lights will be oriented approximately parallel with the roof coverings, regardless of the mounting surface.

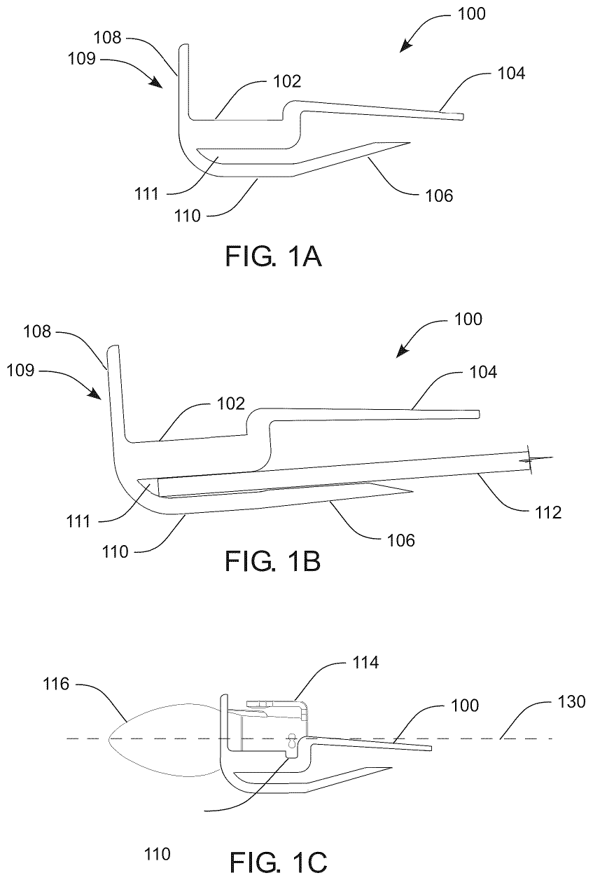

FIG. 1A shows one example of a multi-orientation light clip 100 (hereinafter, light clip). The light clip 100 includes an inline collar 108 (roof covering socket mount 109) structurally configured and coupled to a gutter collar 110 (gutter socket mount 115) that is formed between opposing bottom side supports coupled to the opposing side supports at the inline collar end and extending from the inline collar substantially parallel to the opposing side supports to form a channel 111 to receive a roof covering therebetween. As such, a light socket (not shown) mounted in the inline collar 108 is oriented at a difference angle relative to a light socket (not shown) mounted in the gutter collar 110. While the difference angle between the orientations of the inline collar 108 relative to the gutter collar 110 can vary depending on the design of a particular light clip 100, in FIG. 1A inline collar 108 the gutter collar 110 are oriented relative to one another at a different angle of about 90°. Body section 102 is a pair of opposing side supports coupled to the inline collar 108 and the gutter collar 110, where, in this example, body section 102 extends away from the inline collar 108 in a direction along the gutter collar 110 body to where it couples to an outwardly extending leg (leg) 104. In some examples, the leg 104 is a parallel offset portion of the opposing side supports 102 that provides a gutter rest structurally configured to rest on a gutter top and run along an inside edge of the gutter. As has been described, opposing bottom side supports coupled to the opposing side supports at the inline collar end and extending from the inline collar substantially parallel to the opposing side supports to form a channel to receive a roof covering therebetween.

As such, in the example shown in FIG. 1A, a light socket mounted to the inline collar 108 is generally in alignment with the body section 102 and the leg 104. The body section 102 and the gutter collar 110 are positioned relative to one another to form a slot 111 that is structurally configured to receive a roof covering 112 (FIG. 1B) onto which the light clip 100 is mounted. Slot 111 is structurally configured to receive roof coverings that are generally in line with a desired direction of a light positioned in the inline collar 108. The gutter collar 110 is coupled to a pressure clip 106 extending away from the slot 111 and structurally positioned to exert force on the roof covering 112 toward the body section 102 such that a clamping force is generated between the gutter collar 110 and the body section. FIG. 1C shows a light clip 100 having a light socket 114 and light 116 mounted thereto, where the light socket 114 is oriented generally along a linear axis 130 of the light clip 100.

In one example, the roof covering is a roof shingle that is oriented substantially parallel to the slope of the shingle on a roof of a building, such as a house, for example. As such, the light clip 100 can be used in such orientations where a light is positioned on the roof shingle and extending outward therefrom. It is noted, however, that the light clip having the light socket in this first mounting socket position can be used to clip to any orientation of mounting structure that places a light in a desired position and/or orientation.

Due to the structure of the light clip 100 and the positioning of a string of light sockets therein while attached to a series of shingles along a roof line, the string of lights with the clips can be removed from the shingles simultaneously be pulling on the string of lights away from the light clips and angled outward from the shingles. The light clips tend to rotate at the shingles and pull there from.

The light clips and socket mounts are configured to be applied to a roof, followed by coupling lights into the sockets and orienting the lights in a desired direction depending on which socket mount is used.

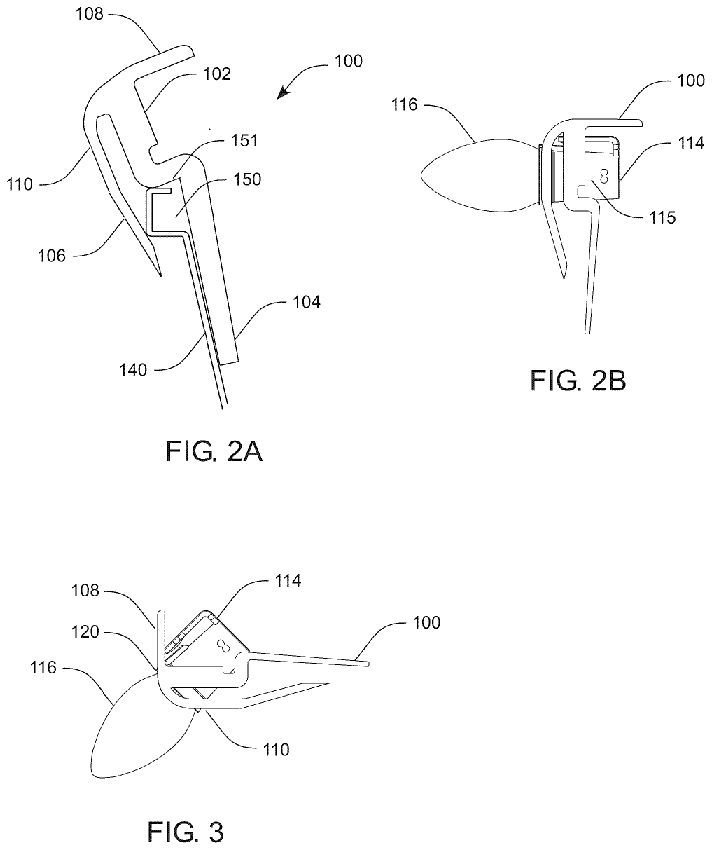

FIG. 2A shows one example of light clip 100 oriented so as to couple to an edge of a roof structure that is oriented in a different direction compared to that shown in FIGS. 1B and IC. In some cases, the different orientation can be a vertical or upward direction compared to the slope of the roof. The example in FIG. 2A shows the light clip 100 mounted to an edge of a rain gutter 140. FIG. 2B thus shows a light socket 114 and light 116 mounted in a second mount of a light clip 100 in an orientation that is substantially out of the linear axis of the light clip 100 (the linear axis orientation is described above). The degree to which the deviation from the linear axis of the light socket is dependent on the design of the device and the angle of the edge of the roof structure. In the example shown in FIG, 2A, the body section 102, the leg 104, and the pressure clip 106 are structurally configured relative to one another to form a space 150 sized and positioned within the light clip 100 to receive the edge of the roof structure, in this case a rain gutter 140. 151 shows the gutter rest structurally configured to rest on a gutter top and run along an inside edge of the gutter. In one example, the light clip 100 engages the rain gutter in the space 150, the pressure clip 106 and the leg 104 exert pressure on the rain gutter to hold the light clip 100 in place. The leg 104 rests against the inside of the rain gutter to stabilize the light clip 100. The light socket 114 can be positioned in the light clip 100 as shown in FIG. 2B or as in FIG. 1C, depending on the light display preference.

Turning to FIG, 3, In addition to the orientations provided by the inline collar 108 and the gutter collar 110, in some examples a light clip 100 can include additional socket mounts oriented in various directions. For example, the light clip shown in FIG. 3 includes a third socket mount 120 positioned intermediate to the inline collar 108 and the gutter collar 110 that allows the positioning of the light 116 in a different orientation compared to the other two mounts. It is noted that the orientations of the first, second, third, etc. mounts are oriented as shown for convenience, and different orientations are considered, provided the positioning of the light is as desired by a user.

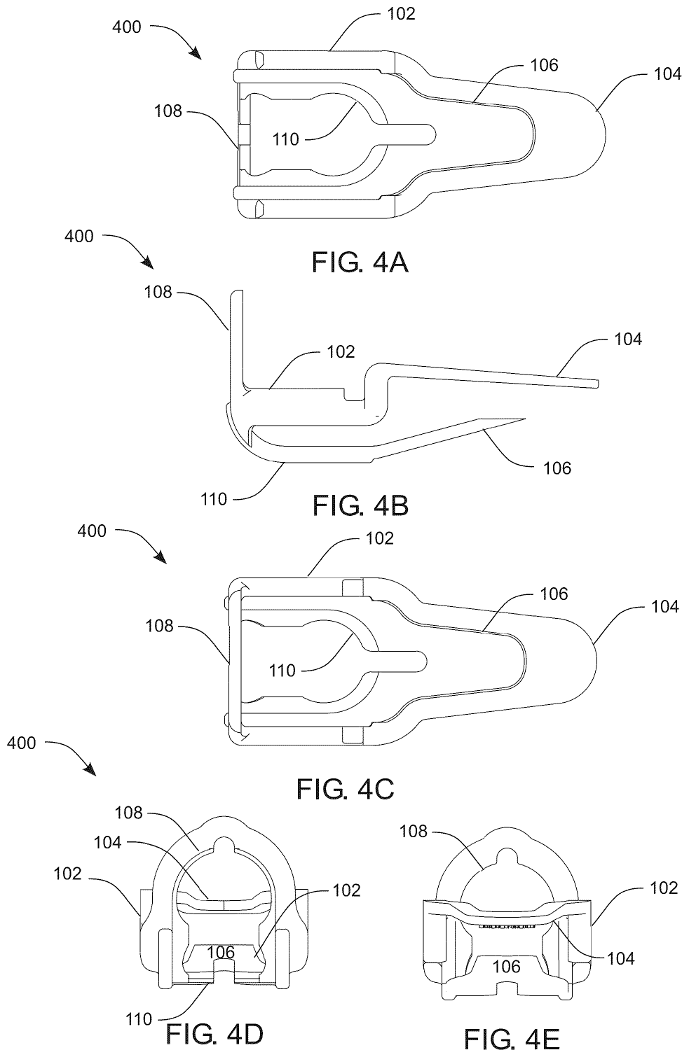

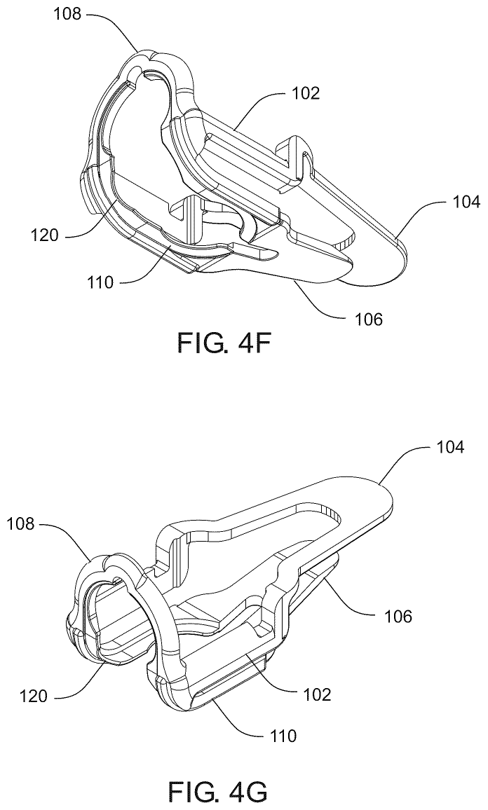

FIGS. 4A, 4B, 4C, 4D and 4E show bottom view, side view, top view, front view, and back view, respectively, of a light clip 400. The light clip 100 includes an inline collar 108 structurally configured and coupled to a gutter collar 110, such that a light socket (not shown) mounted in the inline collar 108 is oriented at a difference angle relative to a light socket (not shown) mounted in the gutter collar 110. While the difference angle between the orientations of the inline collar 108 relative to the gutter collar 110 can vary depending on the design of a particular multi-orientation light clip 100. The inline collar 108 and the gutter collar 110 are oriented relative to one another at a different angle of about 90°. Body section 102 is coupled to the inline collar 108 and the gutter collar 110, where, in this example, body section 102 extends away from the inline collar 108 in a direction along the gutter collar 110 body to where it couples to an outwardly extending leg (leg) 104. As such, in the example shown in FIGS. 4A-E, a light socket mounted to the inline collar 108 is generally in alignment with the body section and the leg 104. The body section 102 and the gutter collar 110 are positioned relative to one another to form a slot 111 that is structurally configured to receive a mounting structure 112 onto which the light clip 100 is mounted. Slot 111 is structurally configured to receive mounting structures that are generally in line with a desired direction of a light positioned in the inline collar 108. The gutter collar 110 is coupled to a pressure clip 106 extending away from the slot 111 and structurally positioned to exert force on the mounting structure 112 toward the body section 102 such that a clamping force is generated between the gutter collar 112 and the body section.

FIGS. 4F and 4G are isometric views of the light clip 400 shown in FIGS. 4A-4E.

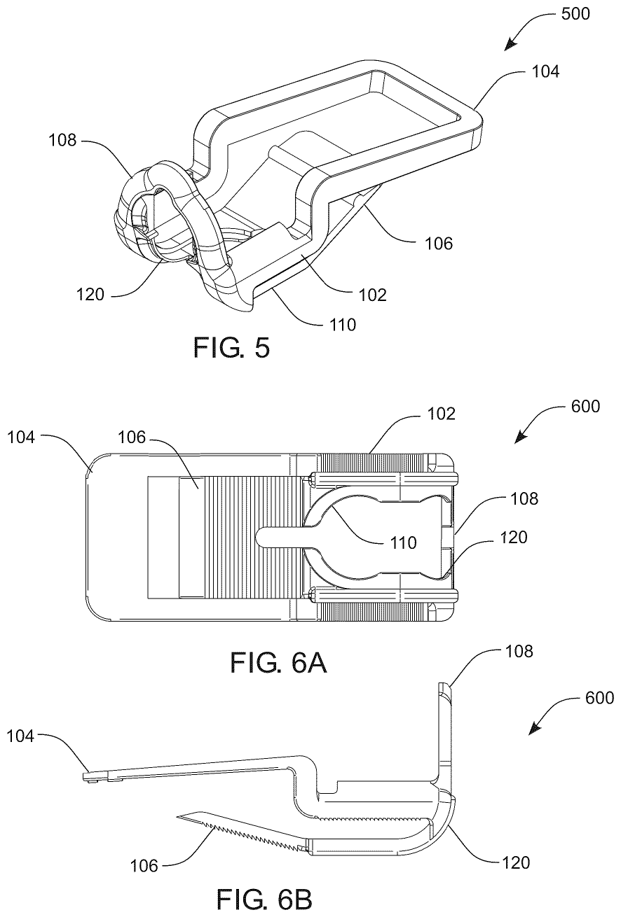

FIG. 5 shows a light clip 500 having an altered design compared to the design of that shown in FIGS. 4A-4E.

FIGS. 6A and 6B show a top view and a side view, respectively, of a light clip 600 having teeth on surfaces that contact mounting supports to provide additional gripping.

What is claimed is:

1. A light clip, comprising:
a roof covering socket mount, further comprising;
an inline collar structurally configured to at least partially encircle a light in a socket mounted in the roof covering socket mount;
opposing side supports coupled to and extending from the inline collar and spaced apart sufficiently to contain a light socket;
opposing bottom side supports coupled to the opposing side supports at the inline collar end and extending from the inline collar substantially parallel to the opposing side supports to form a channel to receive a roof covering therebetween; and
a securing clip coupled to the opposing bottom side supports that is angled upward toward the opposing side supports, such that, when a roof structure is positioned in the channel, the securing clip is elastically deformed beneath the roof structure to secure the light clip; and
a gutter socket mount, further comprising;
a gutter collar formed between the opposing bottom supports and oriented such that a mounted light socket would be positioned between the opposing side supports, the gutter collar configured to at least partially encircle a light in a socket mounted in the gutter socket mount; and
a parallel offset of the opposing side supports providing a gutter rest structurally configured to rest on a gutter top and run along an inside edge of the gutter and the securing clip is elastically deformed on an outside surface of the gutter to secure the light clip.
